(19) United States
(12) Patent Application Publication
(10) Pub. No.: US 2014/0092108 A1
(43) Pub. Date: Apr. 3, 2014

(54) Dynamically Changeable Decorative-Protective Accessory for a Mobile Computing Device

(71) Applicant: Popslate Media, Inc., San Francisco, CA (US)

(72) Inventors: Gregory D. Moon, Bonny Doon, CA (US); Yashar Behzadi, Anaheim, CA (US); Colin J. Karpfinger, San Francisco, CA (US)

(21) Appl. No.: 13/902,356

(22) Filed: May 24, 2013

Related U.S. Application Data
(60) Provisional application No. 61/651,120, filed on May 24, 2012.

(51) Int. Cl. G09G 5/00; G09G 5/12

(52) U.S. Cl. CPC G09G 5/006; G09G 5/12
USPC 345/520

(57) ABSTRACT

A decorative-protective accessory includes a display that can be controlled by a mobile computing device to which the accessory is attached. A mount attaches the accessory to the device. A display is positioned on the mount such that the display is visible to the user when the accessory is attached to the device. An inter-device interface of the accessory receives display data from the device and display control circuitry in the accessory causes the display to shows an image defined by the received display data. The inter-device interface can implement a wireless data transport protocol.

### CROSS -REFERENCE TO RELATED APPLICATIONS

This Application claims priority of U.S. Provisional Patent Application Ser. No. 61/651,120 filed May 24, 2012 entitled “A Method and Apparatus to Dynamically Change the Appearance of a Decorative-Protective Accessory for a Mobile Computing Device” by Gregory D. Moon, MD and Yashar Behzadi, PhD.

### FIELD OF THE INVENTION

The present invention relates generally to mobile computing device accessories and displays.

### BACKGROUND OF THE INVENTION

Mobile computing devices (MCD), such as telephones, tablet computers, and laptop computers, seem to be ubiquitous but still represent a significant investment to many owners of such devices, both in money and effort. If the owner has used her device for any appreciable amount of time, the device has likely been customized by installation and configuration of various applications and by accumulation of personal data such as photographs, videos, and collected music. Such represents a considerable investment of effort and would be difficult to replace if the device were damaged. The owner has also made a significant financial investment in her device. While many such devices can be acquired inexpensively through agreeing to a minimum term contract for service, replacement of a lost or damaged device can be expensive for the owner. As a result, such devices are often insured to avoid the cost of replacement.

To protect these devices, many are often placed within a decorative and/or protective accessory (DPA), such as a case or sheath. Often, such accessories are both protective and decorative in purpose. Conventional decorative-protective accessories are static in nature, allowing no variability in appearance. Accordingly, if a user changes style or aesthetic sensibilities, the only option to change the decorative nature of a conventional accessory is to replace it with another accessory.

What is needed is a decorative and/or protective accessory (DPA) for a mobile computing device in which the appearance of the DPA can be readily changed by the user.

### SUMMARY OF THE INVENTION

In accordance with the present invention, a decorative-protective accessory includes a display that can be controlled by a mobile computing device to which the decorative-protective accessory is attached. In effect, the accessory provides a second display for the device.

The accessory includes a mount that attaches the accessory to the device. For example, the mount can be a decorative and/or protective shell covering substantially all of the back and sides of the device when attached to the device. A display is positioned on the mount such that the display is visible to the user when the accessory is attached to the device. An inter-device interface of the accessory receives display data from the device and display control circuitry in the accessory causes the display to shows an image defined by the received display data. The inter-device interface can implement a wireless data transport protocol.

### A BRIEF DESCRIPTION OF THE DRAWINGS

FIG. 1 is a graphical projection of a decorative-protective accessory in accordance with the invention and a mobile computing device to which the decorative-protective accessory is attachable.

FIG. 2 is a graphical projection of the decorative-protective accessory of FIG. 1.

FIG. 3 is a block diagram showing the mobile computing device of FIG. 1 in greater detail.

FIG. 4 is a block diagram showing the decorative-protective accessory of FIGS. 1 and 2 in greater detail.

FIG. 5 is a diagram showing the mobile computing device of FIG. 1 in communication with a server through a wide area network to illustrate one way that mobile computing device can acquire images to display on the decorative-protective accessory of FIGS. 1 and 2.

FIG. 6 is a block diagram showing an inter-device interface that implements a wired data transport protocol.

### DETAILED DESCRIPTION OF THE INVENTION

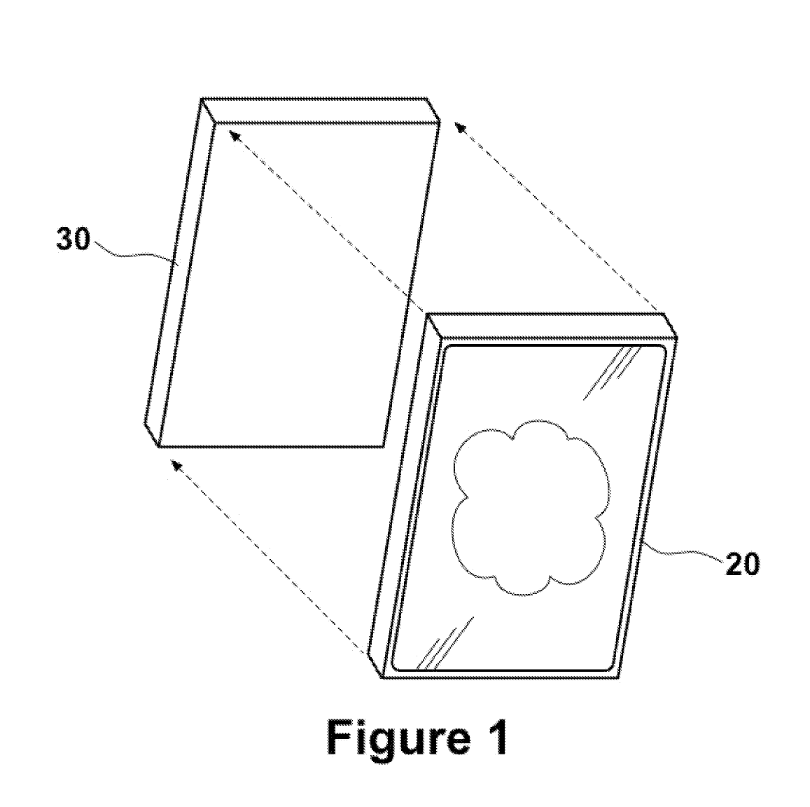

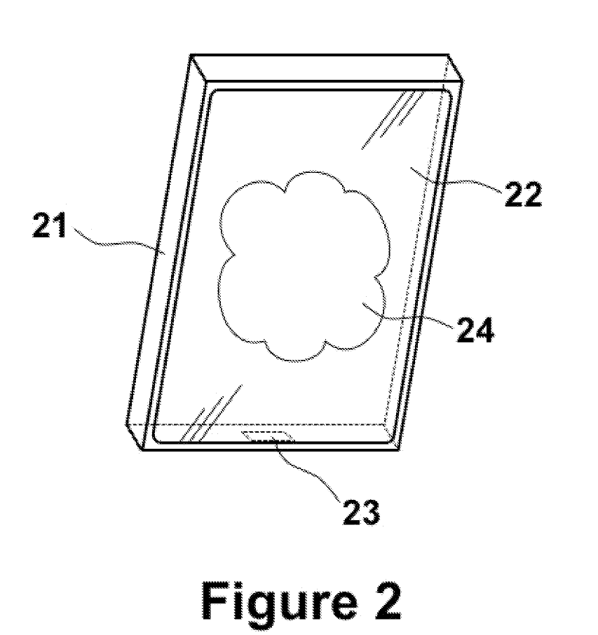

In accordance with the present invention, a decorative-protective accessory (DPA) 20 (FIG. 1) fits on and provides protection for a mobile computing device 30 and includes a display 22 (FIG. 2) that is controlled by logic executing in device 30. In effect, accessory 20 is a snap-on second screen for device 30.

Device 30 can be generally any type of mobile computing device, including mobile telephones, tablet computers, media players, gaming devices, and wearable devices such as watches. Accessory 20 includes a mount 21 that is physically dimensioned such that the fit on device 30 (FIG. 1) is sufficiently snug to prevent spontaneous dissociation of accessory 20 and device 30. Mount 21 can also appose accessory 20 and device 30 using other techniques, such as adhesives, snaps, and magnets for example. In some embodiments, mount 21 (FIG. 2) is a shell that covers and protects substantially all of the back and sides of device 30. Mount 21 attaches accessory 20 to device 30 and preferably maintains the attachment as long as the user wants the attachment to be maintained.

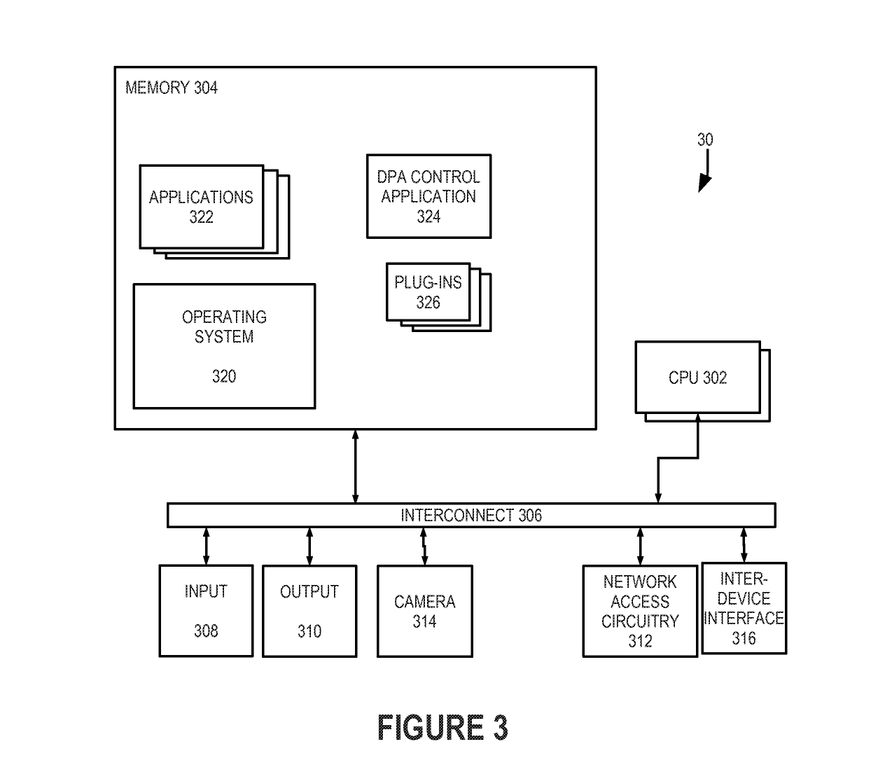

Accessory 20 includes an inter-device interface 23, which can implement wireless or wired data transport protocols. In embodiments in which inter-device interface 23 implements a wired data transport protocol, inter-device interface 23 is a data port that is designed and positioned to couple with a corresponding data port of an inter-device interface 316 (FIG. 3) of device 30.

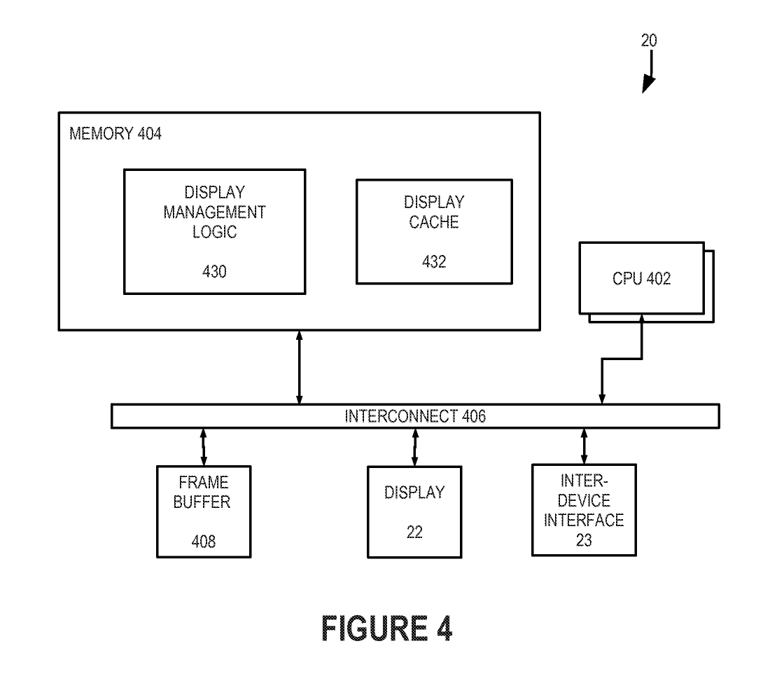

Accessory 20 is shown in greater detail in FIG. 4. Accessory 20 includes one or more microprocessors 402 (collectively referred to as CPU 402) that retrieve data and/or instructions from memory 404 and execute retrieved instructions in a conventional manner. Memory 404 can include persistent memory such as magnetic and/or optical disks, ROM, and PROM and volatile memory such as RAM.

CPU 402 and memory 404 are connected to one another through a conventional interconnect 406, which is a bus in this illustrative embodiment and which connects CPU 108 and memory 106 to a frame buffer 408, a display 22, and an inter-device interface 23.

In some embodiments, frame buffer 408 stores data representing an image displayed in display 22 and can be used to periodically refresh display 22. In other embodiments, display 22 is a type of display that does not require refreshing—such as e-paper for example—and frame buffer 408 provides a mapping from (x, y) pixel addresses to a particular location of display 22 to charge one way or the other.

Display 22 can be any of a number of types of thin displays. In this illustrative embodiment, accessory 20 is powered by a thin-film lithium-ion rechargeable battery that can be charged through a small power port in shell 21 (FIG. 2). Accordingly, it is preferred that, to extend battery life, display 22 is a low-power display such as e-paper, which only uses power when the displayed image is changed. However, in other embodiments, battery life can be sacrificed for other display technologies, including LCD and LED displays.

Inter-device interface 23 sends data to and receives data from device 30 through an inter-device interface 316 (FIG. 3). Inter-device interface 23 (FIG. 4) can be wired or wireless. Examples of wired inter-device interfaces include USB (Universal Serial Bus) and the Apple® Accessory Protocol. Examples of wireless inter-device interfaces include bluetooth® and NFC (Near Field Communications).

Display management logic 430 is all or part of one or more computer processes executing within CPU 402 from memory 404 in this illustrative embodiment but can also be implemented using digital logic circuitry. As used herein, “logic” refers to (i) logic implemented as computer instructions and/or data within one or more computer processes and/or (ii) logic implemented in electronic circuitry.

Display management logic 430 receives and carries out instructions from device 30 through inter-device interface 23. The instructions are to write data to frame buffer 408 for display in display 22. Such instructions generally include (i) data specifying one or more pixels in frame buffer 408 and display 22 and (ii) data to be written to those pixel locations.

In some embodiments, memory 404 includes a display cache 432 to reduce writing of image data to accessory 20 and to thereby reduce power consumption by accessory 20. Display cache 432 stores a number, e.g., ten (10), of the images that were most recently displayed in display 22 along with respective identifiers of the images. In this illustrative embodiment, the identifiers are MD5 digests of the respective images.

In this illustrative embodiment that includes display cache 432, display management logic 430 sometimes receives instructions through inter-device interface 23 to display an image and the image is identified only by its identifier. In response to such instructions, display management logic 430 searches display cache 432 for an image whose identifier matches the identifier received with the instructions. If display management logic 430 finds such an image, display management logic 430 causes the found image to be displayed in display 22. Conversely, if display management logic 430 does not find an image with a matching identifier, display management logic 430 responds to the instructions with a message that no such image is found. The response allows the sender of the instructions to send the image in its entirety. In some embodiments, the sender of the instructions sends the identifier with the image. In other embodiments, display management logic 430 produces the identifier from the image.

Given the specificity and singularity of the task performed by display management logic 430, it is not necessary for accessory 20 to follow general purpose computing device architectures. In particular, accessory 20 can deviate from architectures that would allow additional logic to be installed into accessory 20, e.g., in the form of additional software to be installed therein. As a result, two or more of any of the components of accessory 20 shown in FIG. 4 can be integrated into a single circuit, such as an application-specific integrated circuit (ASIC). Designing the components of accessory 20 to provide no functionality other than that needed to function as described herein can reduce power consumption and further extend battery life.

Mobile computing device 30 is shown in greater detail in FIG. 3. Device 30 includes one or more microprocessors 302 (collectively referred to as CPU 302) that retrieve data and/or instructions from memory 304 and execute retrieved instructions in a conventional manner. Memory 304 can include persistent memory such as magnetic and/or optical disks, ROM, and PROM and volatile memory such as RAM.

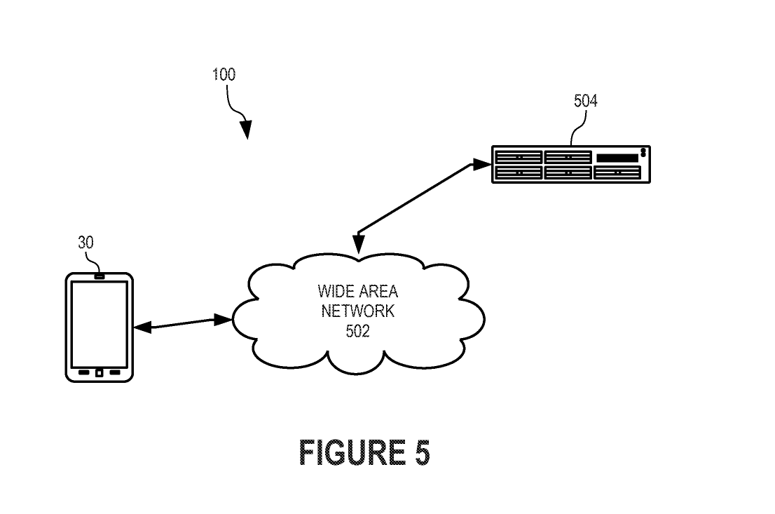

CPU 302 and memory 304 are connected to one another through a conventional interconnect 306, which is a bus in this illustrative embodiment and which connects CPU 302 and memory 304 to one or more input devices 308 and/or output devices 310, network access circuitry 312, a camera 314, and inter-device interface 316. Input devices 308 can include, for example, a keyboard, a keypad, a touch-sensitive screen, a mouse, a microphone. Output devices 310 can include a display—such as a liquid crystal display (LCD)—and one or more loudspeakers. Network access circuitry 312 sends and receives data through a wide area network 502 (FIG. 5) such as the Internet and/or mobile device data networks.

A number of components of mobile computing device 30 are stored in memory 304. In particular, operating system 320, applications 322, and DPA control application 324 are each all or part of one or more computer processes executing within CPU 302 from memory 304 in this illustrative embodiment but can also be implemented using digital logic circuitry.

An operating system such as operating system 320 is logic implemented in a computing device that provides services used by other logic implemented in the computing device. The services typically include management of computer resources such as file systems, peripheral device support, networking services, and computer process management. Generally, most users don't directly use an operating system but rather use logic that in turn uses the operating system to perform various tasks. Examples of operating systems in use today in mobile computing devices include the Android mobile operating system produced by Google, Inc., the iOS operating system produced by Apple Computer, and the Windows 7 Mobile operating system provided by Microsoft Corp.

Applications 322 each define a behavior performed by device 30. Some of applications 322 are pre-installed before acquisition of device 30 by the end user. Others of applications 322 are installed by the user of device 30.

DPA control application 324 defines behavior of device 30 in controlling accessory 20. DPA control application 324 controls accessory 20 by sending instructions to accessory 20 through inter-device interface 316. As noted above, the instructions generally include (i) data specifying one or more pixels in frame buffer 408 (FIG. 4) and display 22 and (ii) data to be written to those pixel locations. Inter-device interface 316 (FIG. 3) is the complement of inter-device interface 23 (FIG. 4).

DPA control application 324 (FIG. 3) provides a user interface, through input devices 308 and output devices 310, through which the user of device 30 can specify the particular image 24 (FIG. 2) to show in display 22. DPA control application 324 captures an image from camera 314 and causes the captured image to be displayed by display 22 in response to a command from the user to do so. In addition, DPA control application 324 acts as an image browser to browse images hosted by a server 504 (FIG. 5) and to select a hosted image for download through wide area network 502 to device 30 and to display on display 22. In response to such a selection, DPA control application 324 downloads the selected image and sends instructions through inter-device interface 316 to cause accessory 20 to display the selected image in display 22.

Since DPA control application 324 directs display management logic 430 (FIG. 4) to write data directly to frame buffer 408 in this illustrative embodiment, DPA control application 324 (FIG. 3) first converts any image to be displayed by display 22 to a bitmap image of the bit depth, color space, and dimensions of display 22.

As described above with respect to display cache 432 (FIG. 4), data transmission and power consumption can be reduced by avoiding re-sending of recently used images. In this illustrative embodiment, rather than send the entire image, DPA control application 324 creates an identifier for an image to be displayed and sends the identifier instead through inter-device interface 316 to accessory 20. As described above, accessory 20 responds with a message indicating that no image with a matching identifier was found in image cache 432. In response to such a message, DPA control application 324 sends the image along with its identifier.

In addition, DPA control application 324 can generate images to display data on display 22. For example, DPA control application 324 can use conventional techniques to determine the current date and time, events scheduled in the new future for the user of device 30, recent news items on news feeds to which the user has subscribed, and weather forecasts for the location of device 30 to compile an image summarizing all this gathered information. Once DPA control application 324 has compiled the image, DPA control application 324 can cause accessory 20 to display the image in display 22. DPA control application 324 can also periodically update this image and cause accessory 20 to display the updated image in display 22. As a result, accessory 20 can provide a current summary of information of interest to the user of device 30 on an ongoing basis.

To save power consumption by accessory 20 in this illustrative embodiment, DPA control application 324 sends only differences between the image to be displayed in display 22 and the image that is currently displayed in display 20. To do this, DPA control application 324 stores data representing one or more of the images most recently sent to accessory 20. When about to send a new image through inter-device interface 316 to accessory 20, DPA control application 324 determines which parts of the image differ from the most recently sent image and sends only the differing parts. Since display management logic 430 processes instructions in the form of pixel locations and pixel data to write to those locations, DPA control application 324 can send instructions to change individual pixels of display 22. However, to avoid sending pixel location data for each and every pixel to change, the pixel location data in instructions processed by display management logic 430 can specify a rectangular region of pixels, up to and including the entire image. DPA control application 324 groups changed parts between the image to be displayed and the most recently displayed image into rectangular regions to minimize the total amount of data to send through inter-device interface 23 to accessory, including both pixel location data and pixel data specifying the image to be displayed at the specified pixel locations.

Some wireless data transport protocols provide very low power consumption at the cost of reduced data bandwidth. One example is the Bluetooth low energy (sometimes referred to as Bluetooth SMART) wireless data transport protocol. Depending upon the resolution and color depth of display 22, such low energy protocols can take twenty seconds or more to transport an image to accessory 20 for display in display 22. Such can be too slow for a user to recognize the change of image in display 22 to be responsive to the user's request to do so.

One solution is to use a faster, more power-intensive wireless data transport protocol. Other solutions are described above: (i) cache images on accessory 20 and (ii) sending only the parts of an image to be displayed that differ from the image currently displayed.

Still other solutions can reduce the user's perception of slow and unresponsive image changes. One is to schedule image changes ahead of time. For example, the user might have designated a number of favorite images to be displayed in display 22. DPA control application 324 can periodically send a different one of the favorite images to accessory 20 for display in display 22. Since the user doesn't know when transportation of the image to accessory 20 began, the user does not perceive any lag in display of the image.

Another solution is for DPA control application 324 to send a low-resolution version of an image followed by a full resolution version of the same image. For example, if the image to be sent by DPA control application 324 is a greyscale image (e.g., 8-bit pixels), DPA control application 324 can send a black and white (e.g., 1-bit pixels) to accessory 20 and follow by sending the full greyscale image immediately thereafter. Accordingly, accessory 20 relatively quickly displays a representation of the greyscale image to indicate to the user that the command to change the image has been received and transportation of the image is under way.

In addition to providing such services itself, DPA control application 324 provides an interface (an application programming interface, API) through which other applications, such as any of applications 322 (FIG. 3), can request changes to the image displayed by display 22. For example, a social networking application, when a new message is received, can request that DPA control application 324 superimpose an icon indicating a new message has been received over the image displayed by display 22.

In addition, functionality of DPA control application 324 can be augmented by installation in device 30 of one or more plug-ins 326. For example, one of plug-ins 326 can cause DPA control application 324 to super-impose the current time over a portion of the image displayed in display 22. Plug-ins and the manner in which they augment the functionality of other logic is well-known and not described herein.

One of the advantages of using a wireless data transport protocol between accessory 20 and device 30 is that device 30 and accessory 20 remain in communication with one another even when accessory 20 is not mounted on device 30. Thus, accessory 20 can continue to display data controlled by device 30 when accessory is not attached to device 30. Accessory 20 can therefore continue to provide information services on behalf of device 30 even while device 30 is placed on a charging cradle in which accessory 20 does not fit. In addition, accessory 20 can pair with computing devices other than device 30 to receive images to display in display 22. Accordingly, a user of device 30 can use another device, such as a laptop or desktop computer, to find images to display in display 22.

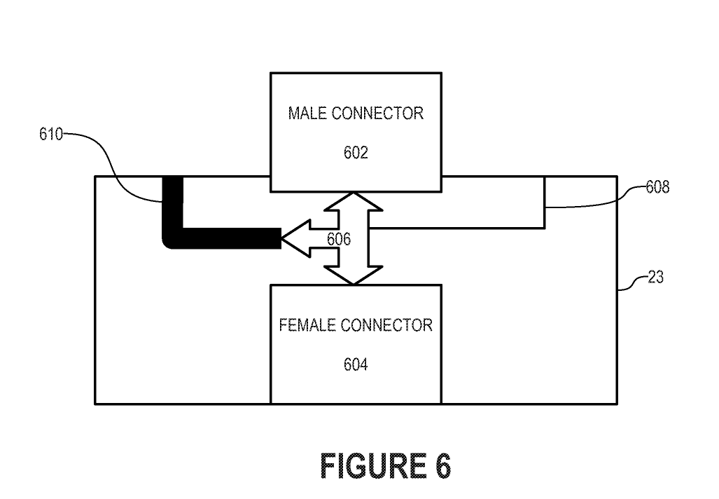

FIG. 6 shows an embodiment of inter-device interface 23 that implements a wired data transport protocol. In this illustrative embodiment, inter-device interface 23 is separable from the remainder of accessory 20 (FIG. 2). Thus, accessory 20 can be attached to device 30 without inter-device interface 23, and inter-device interface 23 can be attached to device 30 by insertion of male connector 602 into a complementary female connector of device 30. A housing of inter-device interface 23 is dimensioned such that the housing fits with accessory 20 to present a look and feel of a single, integrated housing in this illustrative embodiment.

Inter-device interface 23 includes a female connector 604 and a wired connection 606 between female connector 604 and male connector 602. In this illustrative embodiment, male connector 602 and female connector 604 are Lightning® connectors from Apple Computer of Cupertino, California and, with wired connection 606, support addressed inter-device communications.

Inter-device interface 23 includes a wired connection 610 that is attached to wired connection 606 and, when attached to the remainder of accessory 20, is also attached to interconnect 406 (FIG. 4). As a result, display management logic 430 can communicate with device 30 through male connector 602 (FIG. 6). Since male connector 602 and female connector 604 support addressed inter-device communications, display management logic 430 can distinguish communications intended for accessory 20 from other communications through wired connection 606.

Power wires 608 of inter-device interface 23 are connected to power wires of wired connection 606 and, when inter-device interface 23 is attached to the remainder of accessory 20, charge a battery of accessory 20 and power accessory 20.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. An accessory for a mobile computing device that includes a first display, the accessory comprising:
a mount that attaches the accessory to the mobile computing device;
a second display that is different from the first display and that is attached to the mount such that the second screen is visible to a user when the accessory is attached to the mobile computing device;
display control circuitry that is operatively coupled to the second display and that is configured to control an image displayed by the second display in accordance with display data received from the mobile computing device; and
an inter-device interface that is operatively coupled to the display control circuitry and that effects receipt of the display data from the mobile computing device.

2. The accessory of claim 1 further comprising:
a storage medium that is operatively coupled to and readable by the display control circuitry and that stores display control logic that, at least in part, is executable by and defines the behavior of the display control circuitry.

3. The accessory of claim 1 further comprising a battery operatively coupled to the mount, the second display, the display control circuitry, and the inter-device interface.

4. The accessory of claim 1 wherein the inter-device interface implements a wireless data transport protocol.

5. The accessory of claim 1 wherein the inter-device interface implements a wired data transport protocol.

6. A tangible computer readable medium useful in association with a mobile computing device that includes one or more processors and a memory, the computer readable medium including computer instructions that are configured to cause the mobile computing device, by execution of the computer instructions in the one or more processors from the memory, to control an image displayed by an accessory in communication with the mobile computing device by at least:
obtaining image data that represents a next image to be displayed by the accessory;
sending the image data to the accessory in a manner that causes the accessory to display the next image in a display screen that is attached to a mount of the accessory that in turn attaches the accessory to the mobile computing device such that the display screen is visible to a user when the accessory is attached to the mobile computing device.

7. The computer readable medium of claim 6 wherein obtaining image data comprises:
retrieving the image data from a remotely located server computer through a computer network.

8. The computer readable medium of claim 6 wherein obtaining image data comprises:
retrieving the image data from a camera of the mobile computing device.

9. The computer readable medium of claim 6 wherein obtaining image data comprises:
retrieving original image data; and
deriving the image data from the original image data by conversion to dimensions and a color depth of the display screen.

10. The computer readable medium of claim 6 wherein sending the image data comprises:
sending image identification data that identifies the next image.

11. The computer readable medium of claim 10 wherein the computer instructions are configured to cause the mobile computing device to control an image displayed by an accessory in communication with the mobile computing device by at least also:
receiving data from the accessory that indicates that the image identification data does not identify any image stored by the accessory; and
in response thereto, sending the image data to the accessory.

12. The computer readable medium of claim 6 wherein sending the image data comprises:
deriving a low-resolution image from the next image;
sending low-resolution image data, which represents the low-resolution image, to the accessory in a manner that causes the accessory to display the low-resolution image in the display screen; and
thereafter, sending the image data to the accessory in a manner that causes the accessory to display the next image in a display screen.

13. The computer readable medium of claim 6 wherein sending the image data comprises:
identifying a predetermined time at which the next image is to be sent to the accessory; and
at the predetermined time and without requiring human intervention, sending the image data to the accessory in a manner that causes the accessory to display the next image in a display screen.
